(19) United States
(12) Patent Application Publication
(10) Pub. No.: US 2026/0362024 A1
(43) Pub. Date: Nov. 12, 2026

(54) IMAGING DEVICE

(71) Applicant: Japan Display Inc., Tokyo (JP)

(72) Inventors: Yoshiro AOKI, Tokyo (JP); Hirondo NAKATOGAWA, Tokyo (JP); Hitoshi TANAKA, Tokyo (JP)

(73) Assignee: Japan Display Inc., Tokyo (JP)

(21) Appl. No.: 19/672,741

(22) Filed: May 11, 2026

(30) Foreign Application Priority Data
May 12, 2025 (JP) 2025-079650

(51) Int. Cl. H04N 23/95; G06T 7/571

(52) U.S. Cl. CPC H04N 23/95; G06T 7/571

(57) ABSTRACT

Distance measurement is accurately and rapidly performed by using a coded aperture.

The object is achieved by a following configuration. Specifically, provided is an imaging device including: a lens; an optical sensor that receives light; and a coded aperture located close to the lens and disposed between the lens and an imaging target, in which the coded aperture has a first coded aperture and a second coded aperture, the first coded aperture and the second coded aperture are in a similitude relation with each other, the first coded aperture is larger than the second coded aperture in size, the first coded aperture is used to measure an object located at a first distance from a center of the lens, and the second coded aperture is used to measure an object located at a second distance that is shorter than the first distance, from the center of the lens.

### CROSS-REFERENCE TO RELATED APPLICATION

The present application claims priority from Japanese Patent Application JP 2025-079650 filed on May 12, 2025, the content of which is hereby incorporated by reference into this application.

### BACKGROUND OF THE INVENTION

### (1) Field of the Invention

The present invention relates to an imaging device using a coded imaging method.

### (2) Description of the Related Art

Imaging with a camera means capturing a three-dimensional world into a two-dimensional image. An ordinary camera forms a clear image at a focus portion, but the further away from the focus portion the more the image blurs.

Meanwhile, there is a demand for realizing all-in focus image display that enables display of a clear image on an entire screen, or realizing a three-dimensional image. For meeting the demand, it is necessary to obtain information associated with distances between a lens and respective positions of imaging targets.

In “Image and Depth from a Conventional Camera with a Coded Aperture, Anat Levin Rob Fergus et al.,” a description of a technology is made in which distance information is measured and calculated along with camera imaging by using a coded aperture having a special shape. In “Coded Aperture Pairs for Depth from Defocus and Defocus Deblurring, Changyin Zhou Stephen Lin Shree K. Nayar,” a description of a technology is made in which a pair of a pattern for eliminating blurs on an image and a pattern for acquiring distance information is used for a coded aperture.

### SUMMARY OF THE INVENTION

In camera imaging, there is known a method in which information associated with a depth distance to an imaging target object is acquired by calculation using image data captured and recorded through an aperture having a specific pattern shape. This type of aperture will be hereinafter referred to as a coded aperture where appropriate. According to this method, an individual suitable distance range is limited at the time of distance measurement depending on a difference in optical characteristics such as an effective aperture diameter and a focal position. One of solutions for the problem of this limitation is to change a focal position itself. However, this method requires physical lens-driving to adjust the focus, and rapid handling to adjust the focus is difficult to perform. Moreover, for cameras having a large effective aperture diameter, an amount of change in blur significantly increases in an area on a side closer to the camera than the focus point, for example, and therefore, problems such as a decrease in the total measurable range may arise.

The present invention has been developed to solve the aforementioned problems. Main specific solutions are as follows.
(1) An imaging device including: a lens; an optical sensor that receives light; and a coded aperture located close to the lens and disposed between the lens and an imaging target, in which the coded aperture has a first coded aperture and a second coded aperture; the first coded aperture and the second coded aperture are in a similitude relation with each other; the first coded aperture is larger than the second coded aperture in size; the first coded aperture is used to measure an object located at a first distance from a center of the lens; and the second coded aperture is used to measure an object located at a second distance that is shorter than the first distance, from the center of the lens.
(2) The imaging device according to (1), in which a focal distance of the lens for measuring the object located at the first distance from the center of the lens is equal to a focal distance of the lens for measuring the object located at the second distance from the center of the lens.
(3) The imaging device according to (1), in which the lens is configured with a lens system including a plurality of lenses, and the center of the lens corresponds to a center of the plurality of combined lenses.
(4) The imaging device according to (2), in which the lens is configured with a lens system including a plurality of lenses, and the focal distance of the lens corresponds to a focal distance of the plurality of combined lenses.
(5) The imaging device according to (1), in which the second coded aperture similar to the first coded aperture in shape is produced by removing a part of the first coded aperture.
(6) The imaging device according to (1), in which the second coded aperture similar to the first coded aperture in shape is produced by removing an outer circumferential portion of the first coded aperture.
(7) The imaging device according to (1), further including a mechanism that calculates distances from the center of the lens to the objects with use of a depth from defocus method on the basis of measurement data obtained by imaging the imaging target.

### BRIEF DESCRIPTION OF THE DRAWINGS

FIG. 1 illustrates an optical model of an imaging device using a lens;

FIG. 2 illustrates an example of a coded aperture;

FIG. 3 is a cross-sectional diagram of an imaging system which uses an aperture having a coded aperture;

FIG. 4 illustrates imaging conditions of a first imaging system;

FIG. 5 illustrates a blur measurement result obtained by the first imaging system;

FIG. 6 illustrates imaging conditions of a second imaging system;

FIG. 7 illustrates a blur measurement result obtained by the second imaging system;

FIG. 8 illustrates imaging conditions of an imaging system according to Embodiment 1;

FIG. 9 illustrates a blur measurement result obtained by the imaging system according to Embodiment 1;

FIG. 10 illustrates an example of a first coded aperture used in an imaging system according to Embodiment 2;

FIG. 11 illustrates an example of a second coded aperture used in the imaging system according to Embodiment 2;

FIG. 12 is a diagram illustrating a relation between the first coded aperture and the second coded aperture according to Embodiment 2;

FIG. 13 illustrates imaging conditions of a first imaging system according to Embodiment 2;

FIG. 14 illustrates a blur measurement result obtained by the first imaging system according to Embodiment 2;

FIG. 15 illustrates imaging conditions of a second imaging system according to Embodiment 2; and

FIG. 16 illustrates a blur measurement result obtained by the second imaging system according to Embodiment 2.

### DETAILED DESCRIPTION OF THE PREFERRED EMBODIMENTS

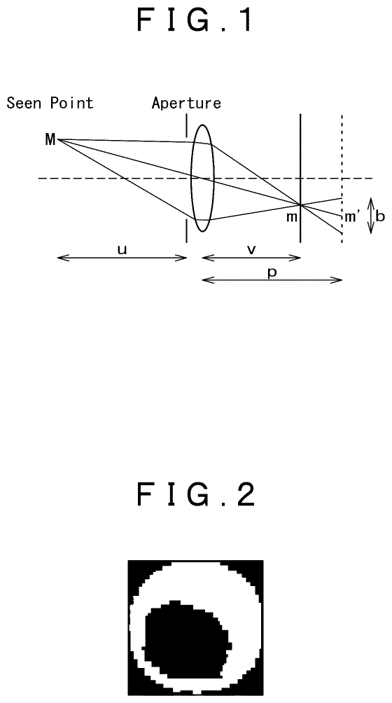

A camera is provided as means for capturing a three-dimensional world into a two-dimensional image. For restoring a three-dimensional image or an all-in-focus image from the two-dimensional image thus formed, a distance from respective imaging points to a lens center needs to be acquired. FIG. 1 is an optical model of a camera using a lens. When an object at a distance of u is measured using a lens having a focal length of f in FIG. 1, entire incident light converges at a point on a surface having a distance of v, in accordance with the lens formula expressed by equation (1).

1/f=1/u+1/v (1)

When a position having a distance of p on an imaging plane is aligned with the point having a distance of v, a focused image is obtained. However, if the position having the distance of p is shifted from the point having a distance of v frontward or backward, the applied light is projected in the form of a circle having a size of b, as expressed by equation (2). This circle is also called a circle of confusion.

b=(a/v)|v−p| (2)

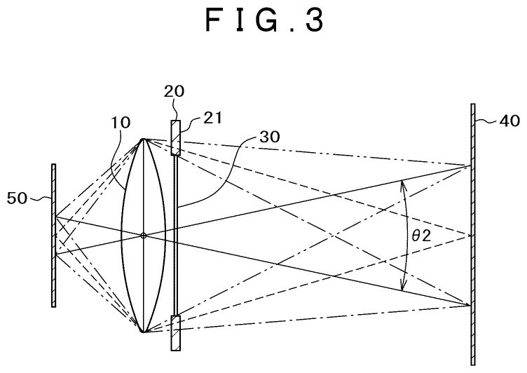

In equation (2), a represents an aperture size. When the size of b exceeds a pixel size, blur appears in an image. Since the depth of field defined for each camera is limited, an object located at a depth far from the focal position appears blurry in the image. The size of this blur is dependent on the distance from the camera to the object as can be understood from equations (1) and (2). Therefore, conversely, by measuring the blur, the distance from the camera to the imaging target is estimable. This method is called a depth from defocus (DFD) method. For effectively measuring distances based on the DFD method, various patterns of coded aperture have been proposed. Among those patterns, first, a coded aperture illustrated in FIG. 3 will be discussed by way of example in the present specification.

Note that, for distance measurement using the DFD method, a suitable distance measurement range is defined for each distance measurement. Calculation errors tend to increase in areas out of this suitable distance measurement range. Accordingly, accurate distance measurement is difficult to achieve in these areas.

This problem can be solved by appropriately adjusting the focal position. However, this focal position adjustment requires lens movement that is difficult to achieve at high speed. Moreover, a precise lens movement mechanism is needed. Furthermore, power for moving the lens is required.

Following embodiments implement a configuration that solves the aforementioned problems and provides a sufficient measurement distance in a wide range. The present invention will be hereinafter described in detail on the basis of these embodiments.

### Embodiment 1

FIG. 3 is a cross-sectional diagram illustrating a case of imaging an imaging target 40 with use of a lens 10. In FIG. 3, the imaging target 40 is located on the right side of the lens 10, and an optical sensor 50 to which an image is projected is located on the left side of the lens 10. The imaging target 40 will be hereinafter also referred to as a subject 40 in some cases. Note that the subject 40 in this case can represent not only a small object, but also a wide target including the background surrounding the small object. A semiconductor imaging element such as a complementary metal oxide semiconductor (CMOS) image sensor and a charge coupled device (CCD) image sensor is employed to constitute the optical sensor 50.

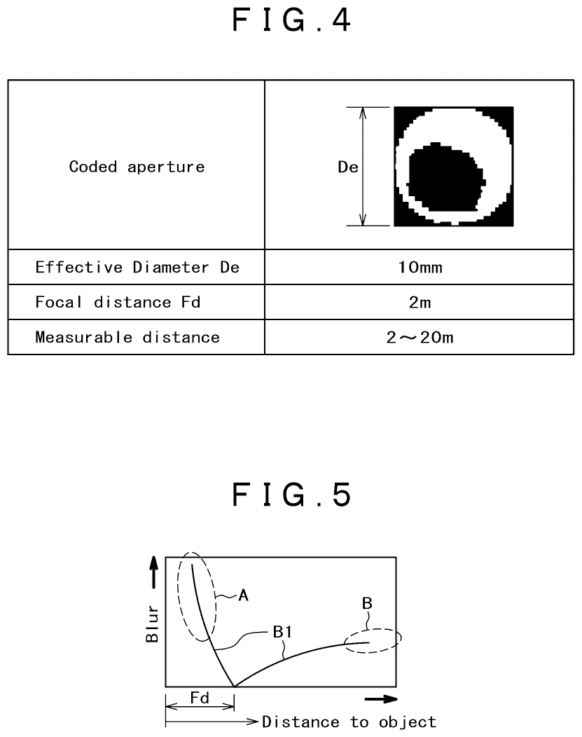

Note that, in the lens 10, generally, the further away from the center thereof the larger the refractive index is, and similarly, the further away from the center thereof the larger the spherical aberration is. However, the spherical aberration of the lens 10 is ignored in FIG. 3 which is a cross-sectional diagram only for purposes of explanation. This applies to FIG. 4 and following figures.

In FIG. 3, light traveling from the center of the subject 40, as indicated by dotted lines, is refracted on the lens 10, and converges at the center of the optical sensor (hereinafter simply referred to as the sensor) 50. Light traveling from an upper end of the subject 40 and passing through the center of the lens 10 advances straight, as indicated by a solid line, and forms an image at a lower end of the sensor 50. Moreover, light traveling from an upper portion of the subject 40 and not passing through the center of the lens 10 is refracted on the lens 10, as indicated by a two-dot chain line, and forms an image at a lower portion of the sensor 50. Furthermore, light traveling from a lower end of the subject 40 and passing through the center of the lens 10 advances straight, as indicated by a solid line, and forms an image at an upper end of the sensor 50. In addition, light traveling from a lower portion of the subject 40 and not passing through the center of the lens 10 is refracted on the lens 10, as indicated by a one-dot chain line, and forms an image at an upper portion of the sensor 50.

In FIG. 3, an aperture 20 is disposed between the lens 10 and the subject 40 and at a position close to the lens 10. The aperture 20 herein has a coded aperture 30. Moreover, a second aperture 21 for defining a light passing amount is located on the outside of the coded aperture 30. In the present description, the coded aperture 30 and the second aperture 21 are collectively referred to as the aperture 20. Note that the second aperture 21 is not a required item. An outer frame of the coded aperture 30 may function as the second aperture 21.

While only the one lens 10 is illustrated in FIG. 3, a plurality of lenses may be used for more accurate control. In this case, the lens 10 in FIG. 3 is considered as a combined lens system including a plurality of lenses.

FIGS. 4 and 5 illustrate specific conditions and a measurement result, respectively, of distance measurement carried out with use of the DFD method in the configuration illustrated in FIG. 3. In a table of FIG. 4, “Coded aperture” represents a coded aperture pattern which is the same as that in FIG. 2. In FIG. 4, a portion expressed in white indicates an area through which light passes, and a black portion indicates a light-shielding area. In FIG. 4, De represents an effective diameter (Effective Diameter) of the coded aperture, which is 10 mm. In the table, a focal distance (Focal distance) Fd of the lens is 2 m.

According to the DFD method, first, a blur amount is measured, and a measurement distance is calculated on the basis of the blur amount. FIG. 5 is a graph illustrating a result of a blur amount measurement performed under the conditions in FIG. 4. The horizontal axis in FIG. 5 represents a distance from a lens center to an object, while the vertical axis represents a blur amount at each spot. In FIG. 5, B1 indicates a change in the blur amount, and a portion corresponding to the blur amount of zero is a focal position at which the distance Fd from the lens center is 2 m.

For distance measurement using the DFD method, it is preferable that the change in the blur amount on the vertical axis relative to the horizontal axis in FIG. 5 is an easily calculable change amount. For example, in an area A in FIG. 5, the change in the blur amount relative to the change in the distance is considerably large. In this case, calculation results tend to be unstable, and therefore accurate distance measurement is difficult to achieve. Meanwhile, in an area B in FIG. 5, the change in the blur amount relative to the change in the distance is extremely small. In this case, sufficient data for calculation is difficult to acquire, and therefore, accurate distance measurement is difficult to achieve. Considering these points, a measurement range (Measurable distance) under the conditions illustrated in FIG. 4 is from 2 to 20 m.

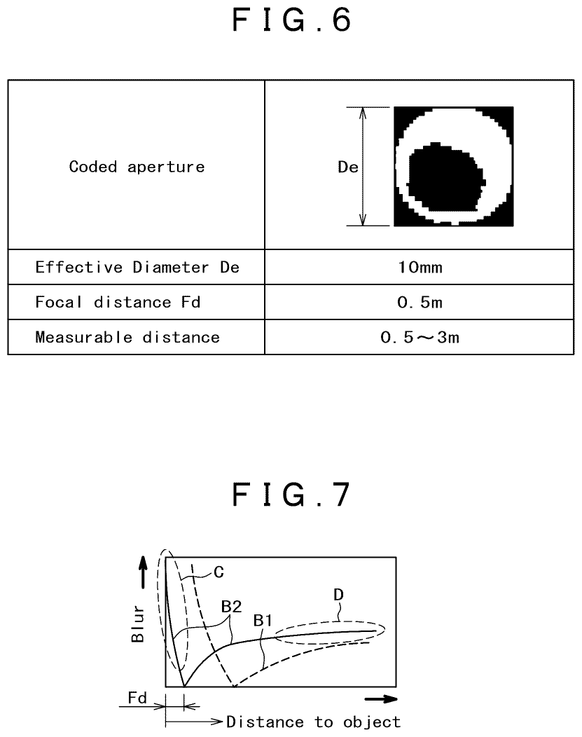

FIG. 6 illustrates conditions for shifting the measurement range to be closer to the lens, while FIG. 7 illustrates a blur measurement result obtained under these conditions. FIG. 6 is a table illustrating measurement conditions, and the coded aperture to be used is identical to that illustrated in FIG. 4. In FIG. 6, the characteristic of the blur is changed by decreasing the focal distance Fd of the lens. FIG. 7 illustrates a blur measurement result. In FIG. 7, a characteristic of the blur corresponding to the conditions in FIG. 6 is indicated by a solid line B2. A dotted line B1 in FIG. 7 is a reprinted line representing the characteristic of the blur in FIG. 5. As indicated by the solid line B2 in FIG. 7, the measurable range is shifted to an area where the distance to the object is further shorter, according to reduction in the focal distance. For example, the measurement range is from 0.5 to 3 m.

As indicated in an area C of the solid line B2 illustrated in FIG. 7, the change in the blur amount is considerably large in an area where the distance to the object is shorter than the focal distance Fd. In this case, the calculation result becomes unstable. Meanwhile, as indicated in an area D, for example, the change in the blur amount relative to the measurement distance is small as the measurement distance increases. In this case, calculation is difficult to carry out. The area D illustrated in FIG. 7 covers an area where the distance to the object is further shorter than that of the area covered by the area B illustrated in FIG. 5. Accordingly, the measurable range is shifted to a range of 0.5 to 3 m according to the change in the focal distance to 0.5 m. In other words, the measurable area can be shifted to a side where the distance to the object is further shorter, but the measurable range decreases.

Meanwhile, for changing the focal distance in the configuration allowed to be equipped with only one lens, the lens to be used needs to be switched to a lens having a different focal distance for each change. In this case, the lens needs to be replaced. Meanwhile, if the lens is configured with a plurality of lenses, interphase positions of the lenses are changed. In any of these cases, mechanical movement of the lens is required, and therefore, sufficient time and mechanical reliability need to be considered.

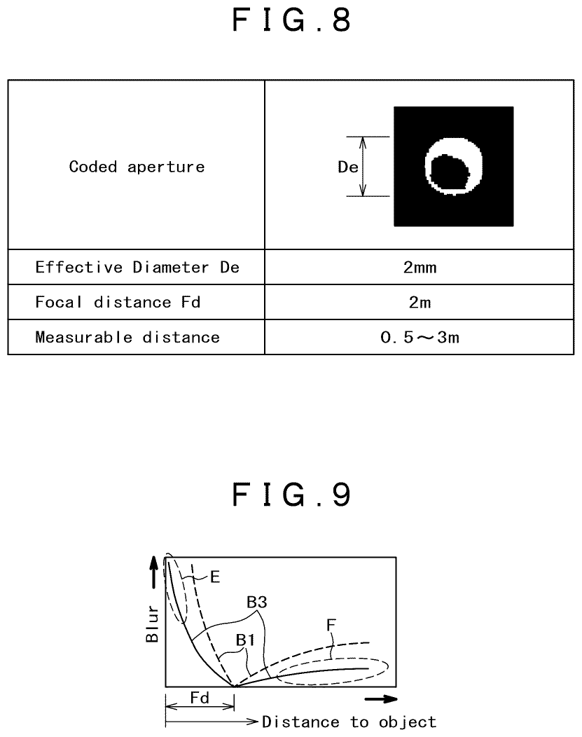

FIGS. 8 and 9 are diagrams illustrating characteristics produced in Embodiment 1. FIG. 8 presents conditions for shifting the measurement range to be closer to the lens without changing the focal distance, i.e., without moving the lens, and FIG. 9 presents a blur measurement result obtained under these conditions. FIG. 8 is a table illustrating measurement conditions. The coded aperture used herein is different from the coded aperture illustrated in FIGS. 4 and 6. A diameter De of the coded aperture in FIG. 8 is 2 mm, which is ⅕ of 10 mm of the diameter De of the coded aperture in FIGS. 4 and 6. Note that the shape of the coded aperture is similar to the shape of the coded aperture in FIGS. 4 and 6. In addition, the focal distance is 2 m which is equal to the focal distance in FIG. 4. In other words, the lens is not moved.

FIG. 9 illustrates a blur measurement result obtained under the conditions in FIG. 8. In FIG. 9, a blur characteristic corresponding to the conditions in FIG. 8 is indicated by a solid line B3. A dotted line B1 in FIG. 9 is a reprinted line representing the characteristic of the blur in FIG. 5. As indicated by the solid line B3 in FIG. 9, a focal distance Fd is equal to the focal distance indicated by the dotted line B1, but the blur amount of the solid line B3 is smaller than the blur amount of the dotted line B1.

As a result, the change in the blur amount decreases particularly in an area where the distance to the object is shorter than the focal distance Fd. Accordingly, calculation can be additionally carried out in this area. However, calculation becomes difficult in an area where the distance to the object becomes further shorter. This area is indicated by E in FIG. 9.

Meanwhile, in an area where the distance to the object is longer than the focal distance Fd, the change in the blur amount is small. In this case, calculation is difficult to carry out. This area is indicated by F in FIG. 9. The area F covers an area where the distance to the object is further shorter than that of area covered by the area B illustrated in FIG. 5. This is due to a decrease in the amount of the light passing through the coded aperture.

Accordingly, the measurable range is shifted to a range of 0.5 to 3 m. In other words, the measurable area can be shifted to an area where the distance to the object is further shorter. However, the measurable range is narrower than the measurable range in FIG. 5. As discussed above, the measurement range can be shifted to an area where the distance to the object is further shorter, by decreasing the diameter of the coded aperture without a necessity of moving the lens.

In addition, replacement of the coded aperture may be mechanically conducted, or may be achieved only by switching electric signals with use of a liquid crystal display device without mechanical driving. A necessity of creating complicated signal circuits can be eliminated by adopting a fixed pattern.

### Embodiment 2

As discussed in Embodiment 1, the present invention changes the size of the coded aperture to change the distance measurable range. This size change requires preparation of a small pattern having a shape similar to the shape of the original coded aperture, for example. However, preparation of such a similar coded aperture may be relatively difficult for some coded apertures.

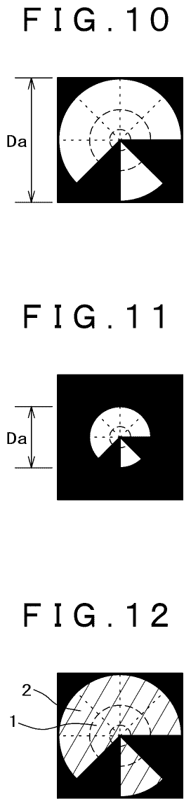

Embodiment 2 provides a coded aperture allowing easy preparation of a similar pattern. FIGS. 10 and 11 each illustrate an example of this pattern. FIG. 10 illustrates an original pattern. The pattern in FIG. 10 is a combination of a fan-shaped pattern having a large angle and a fan-shaped pattern having a small angle. This shape can be formed by concentric circles and radial lines.

A coded aperture in FIG. 11 can be easily created from the original coded aperture in FIG. 10. Both the coded aperture in FIG. 11 and the coded aperture in FIG. 10 may be prepared and switched for each use. If a liquid crystal display device is used to form the coded aperture, for example, the coded aperture can be easily switched by using the single liquid crystal display device (hereinafter, this coded aperture will also be referred to as a liquid crystal aperture).

FIG. 12 illustrates an example of this case. A liquid crystal display device in FIG. 12 uses a fixed pattern. A pixel electrode is divided into an area 1 and an area 2. For using the coded aperture in FIG. 10 (a first coded aperture), both the area 1 and the area 2 of the pixel electrode are turned on. For using the coded aperture in FIG. 11 (a second coded aperture), only the area 2 is turned off. By using the liquid crystal aperture, immediate switching of the coded aperture is achievable only by electric signals without a necessity of mechanical movement. In other words, for turning on both the area 1 and the area 2, a first pixel electrode constituted by the pixel electrode in the area 1 and the pixel electrode in the area 2 is used. For turning on only the area 1 (i.e., for turning off only the area 2), a second pixel electrode corresponding to the pixel electrode in the area 1 is used. The coded aperture in FIG. 11 (second coded aperture) obtains a shape having a similitude relation with the first coded aperture by turning off (removing) the pixel electrode in the area 2 located in a part (outer circumferential portion) of the coded aperture in FIG. 10 (first coded aperture).

Meanwhile, for forming many shapes of the coded aperture by using the single liquid crystal display device, a liquid crystal display device of a type which includes small pixels arranged in a matrix shape may be employed. This configuration is suitable for forming a relatively large-sized coded aperture. In this case, however, a large number of wires are required as compared with a case of the fixed pattern.

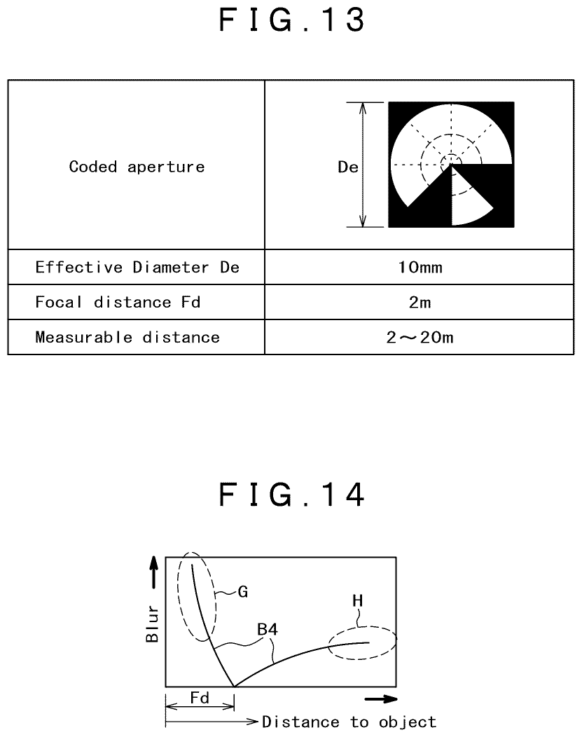

FIGS. 13 and 14 illustrate specific conditions and a measurement result, respectively, of distance measurement performed with use of the DFD method in the configuration illustrated in FIG. 3. FIG. 13 is a figure corresponding to FIG. 4 in Embodiment 1. FIG. 13 is different from FIG. 4 only in the coded aperture (Coded aperture). Specifically, an effective aperture diameter (Effective Diameter) De of the coded aperture is 10 mm and the measurement range (Measurable distance) is from 2 to 20 m in FIG. 13.

FIG. 14 is a graph illustrating a result of a blur amount measured under the conditions presented in FIG. 13. FIG. 14 is a graph corresponding to FIG. 5 in Embodiment 1. Items in FIG. 14 are similar to those in FIG. 5. Specifically, in FIG. 14, the horizontal axis represents a distance to an object, while the vertical axis represents a blur amount at each spot. In addition, a change in the blur amount in FIG. 14 is indicated by B4. In FIG. 14, a portion exhibiting the blur amount of zero corresponds to a focus position, and the distance Fd from the lens is 2 m.

An area G in FIG. 14 corresponding to the area A in FIG. 5 is an area where the change in the blur amount is considerably large. Accordingly, a calculation result tends to be unstable, and therefore accurate distance measurement is difficult to achieve in this area. Meanwhile, an area H in FIG. 14 is an area corresponding to the area B in FIG. 5. Specifically, the change in the blur amount relative to the change in the distance is extremely small in this area. Accordingly, sufficient data required for calculation is difficult to collect, and therefore accurate distance measurement is difficult to achieve in this area.

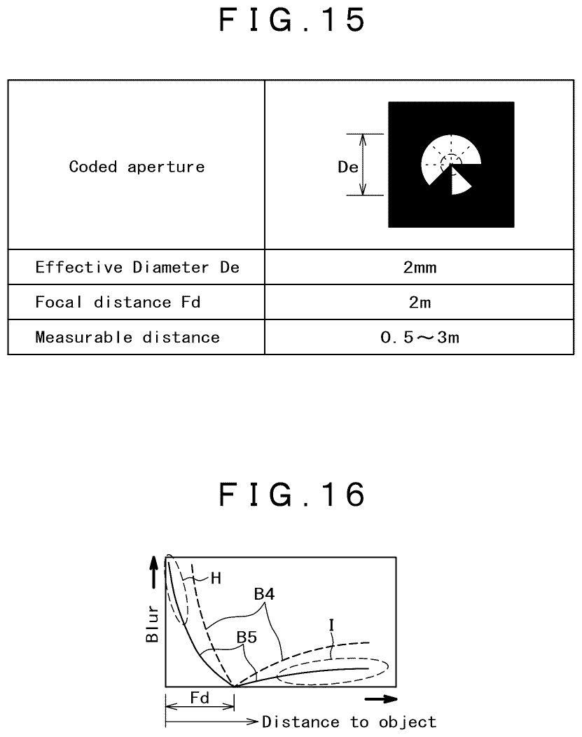

FIG. 15 illustrates conditions for shifting the measurement range to be closer to the lens without changing the focal distance, i.e., without moving the lens, and FIG. 16 illustrates a blur measurement result obtained under these conditions. FIGS. 15 and 16 correspond to FIGS. 8 and 9 in Embodiment 1.

FIG. 15 is a table illustrating measurement conditions. The coded aperture in FIG. 15 is equivalent to a coded aperture formed by cutting off a part of (removing an outer circumferential portion of) the coded aperture illustrated in FIG. 13. Other configurations in FIG. 15 are identical to the corresponding configurations of Embodiment 1 in FIG. 9. Specifically, a diameter De of the coded aperture in FIGS. 15 and 16 is 2 mm, which is ⅕ of the coded aperture De in FIGS. 13 and 14. A focal distance Fd is 2 m which is equal to the focal distance in FIG. 13. In other words, the lens is not moved.

FIG. 16 illustrates a blur measurement result obtained under the conditions in FIG. 15. FIG. 16 corresponds to FIG. 9 in Embodiment 1. In FIG. 16, a characteristic of the blur corresponding to the conditions in FIG. 15 is indicated by a solid line B5. A dotted line B4 in FIG. 16 is a reprinted line representing the characteristic of the blur in FIG. 14. As indicated by the solid line B5 in FIG. 16, a focal distance Fd is equal to the focal distance indicated by the dotted line B4, but the blur amount of the solid line B5 is smaller than the blur amount of the dotted line B4.

Accordingly, the change in the blur amount decreases particularly in an area where the distance from the lens center to the object (second distance) is shorter than the focal distance Fd. In this case, calculation can be additionally carried out in this area. However, calculation becomes difficult in an area where the distance to the object becomes further shorter. This area is indicated by H in FIG. 16.

Meanwhile, in an area where the distance from the lens center to the object (first distance) is longer than the focal distance Fd, the change in the blur amount is small, and therefore calculation is difficult to perform. This area is indicated by I in FIG. 16. The area I covers an area where the distance to the object is further shorter than that of the area covered by the area H illustrated in FIG. 14. This is due to a decrease in the amount of the light passing through the coded aperture.

Accordingly, the measurable range is shifted to a range of 0.5 to 3 m. In other words, the measurable area can be shifted to an area where the distance to the object is further shorter. However, the measurable range is narrower than the measurable range in FIG. 13. The details in FIG. 16 as discussed above are similar to the details in FIG. 9 explained in Embodiment 1.

Different data is obtained from different patterns of the coded aperture. It is therefore important to use a pattern allowing easy calculation. The present invention changes the coded aperture shape into a similar shape according to the measurement distance to obtain optimal distance measurement data without changing the focal distance of the lens system. Embodiment 2 forms a coded aperture in a similar shape (in a similitude relation) by cutting off a part of (removing an outer circumferential portion of) the original coded aperture, and obtains optimal distance measurement data on the basis of the similar coded aperture.

While the single lens is illustrated in FIG. 3, a plurality of lenses are often used in actual situations. Assuming that a plurality of lenses are collectively referred to as a lens system, the focal distance of the lens discussed in Embodiment 1 and Embodiment 2 can be defined as a distance from the center of the lens system combining the plurality of lenses to the focal point of the lens system combining the plurality of lenses.

What is claimed is:

1. An imaging device comprising:
a lens;
an optical sensor that receives light; and
a coded aperture located close to the lens and disposed between the lens and an imaging target, wherein
the coded aperture has a first coded aperture and a second coded aperture,
the first coded aperture and the second coded aperture are in a similitude relation with each other,
the first coded aperture is larger than the second coded aperture in size,
the first coded aperture is used to measure an object located at a first distance from a center of the lens, and
the second coded aperture is used to measure an object located at a second distance that is shorter than the first distance, from the center of the lens.

2. The imaging device according to claim 1, wherein a focal distance of the lens for measuring the object located at the first distance from the center of the lens is equal to a focal distance of the lens for measuring the object located at the second distance from the center of the lens.

3. The imaging device according to claim 1, wherein
the lens is configured with a lens system including a plurality of lenses, and
the center of the lens corresponds to a center of the plurality of combined lenses.

4. The imaging device according to claim 2, wherein
the lens is configured with a lens system including a plurality of lenses, and
the focal distance of the lens corresponds to a focal distance of the plurality of combined lenses.

5. The imaging device according to claim 1, wherein each of the first coded aperture and the second coded aperture is configured with a single liquid crystal device.

6. The imaging device according to claim 5, wherein the liquid crystal display device is configured with a first pixel electrode corresponding to the first coded aperture, and a second pixel electrode corresponding to the second coded aperture.

7. The imaging device according to claim 5, wherein the liquid crystal display device has a configuration in which a plurality of pixel electrodes are disposed in a matrix manner, and forms the first coded aperture and the second coded aperture by turning on or off the pixel electrodes.

8. The imaging device according to claim 1, wherein the second coded aperture similar to the first coded aperture in shape is produced by removing a part of the first coded aperture.

9. The imaging device according to claim 1, wherein the second coded aperture similar to the first coded aperture in shape is produced by removing an outer circumferential portion of the first coded aperture.

10. The imaging device according to claim 1, further comprising a mechanism that calculates distances from the center of the lens to the objects with use of a depth from defocus method on a basis of measurement data obtained by imaging the imaging target.
